(19) United States
(12) Patent Application Publication
(10) Pub. No.: US 2005/0201110 A1
(43) Pub. Date: Sep. 15, 2005

(54) Hanging light fixture

(75) Inventors: Harold J. Brown, Poultney, VT (US); George B. Chandler, Castleton, VT (US)

Correspondence Address: Liniak, Berenato & White;Ste. 240, 6550 Rock Spring Drive, Bethesda, MD, 20817, US

(73) Assignee: HUBBARDTON FORGE

(21) Appl. No.: 10/798,399

(22) Filed: Mar. 12, 2004

(51) Int. Cl. F21S 8/06

(52) U.S. Cl. 362/405; 362/406

(57) ABSTRACT

A hanging light fixture that incorporates an adjustment mechanism that allows the body of the light fixture to be easily rotated and adjusted to facilitate maintenance and enhance the light fixture's visual effect. The preferred embodiment of the light fixture is comprised of a stem assembly that extends through the fixture body and engages a retaining washer that is welded to the distal end of the stem assembly. A set screw, extends through the fixture body and frictionally engages the retaining washer to maintain the rotational position of the hanging light fixture body relative to the stem assembly. The lighting fixture is adjusted by disengaging the set screw and rotating the light fixture body to an adjusted position, and then re-tightening the set screw to lock the fixture body in the adjusted position.

### BACKGROUND OF THE INVENTION

1. Field of the Invention

The invention generally relates to lighting fixtures. The invention more specifically applies to a mechanism for controlling the orientation of chandeliers and other hanging light fixtures.

2. Description of the Background Art

Multiple hanging lighting fixture designs are readily available in most lighting and furniture stores. Hanging light fixtures come in a variety of styles and may have multiple design configurations. Hanging light fixtures include chandeliers and other types of suspended lighting. Hanging light fixtures are generally comprised of a stem assembly having a first end connected to the ceiling and a second end connected to the body of the hanging light fixture. Lighting element holders extend from the body of the light fixture and are arrayed in a decorative display.

However, hanging light fixture design typically focuses on creating an ornamental display rather than on practical considerations, such as easy maintenance and adjustment. Once a hanging light fixture is installed, adjusting the position of the fixture requires the rotation of the entire fixture and/or the loosening of one or more of the fixture's primary structural connectors. Depending on the size of the fixture, this adjustment may be a major task. The ability to rotationally adjust a hanging lighting fixture to achieve the best visual effect is particularly important with asymmetrical chandeliers in applications in which different events require different lighting effects and the modification of a preferred primary viewing perspective.

Additionally, simple maintenance, such as changing the fixture's lighting elements or cleaning the fixture, may require a maintenance person with stepladder to repeatedly reposition the ladder to service all the lighting elements. This task would be vastly simplified if the maintenance person could simply rotate the body of the fixture rather than repositioning the ladder. This consideration is particularly important in venues having multiple large chandeliers.

The need exists for a simple and reliable hanging light fixture design that can be easily adjusted to achieve the best visual effect and facilitate easy maintenance. The current invention satisfies these criteria and provides an efficient design that does not incorporate a complex or expensive mechanism, and does not detract from the visual quality of the decorative display. On the contrary, the current design allows the fixture to be easily adjusted to orient the body of the fixture to maximize the fixture's visual effect.

### SUMMARY OF THE INVENTION

The current invention is a hanging light fixture that incorporates an adjustment mechanism that allows the body of the light fixture to be easily rotated and adjusted to facilitate maintenance and enhance the light fixture's visual effect. The preferred embodiment of the hanging light fixture is comprised of a stem assembly that extends through the fixture body and engages a retaining washer that is welded to the distal end of the stem assembly. A set screw, extends through the fixture body and frictionally engages the retaining washer to maintain the rotational position of the hanging light fixture body relative to the stem assembly. The light fixture is adjusted by disengaging the set screw and rotating the fixture body to an adjusted position, and then re-tightening the set screw to lock the fixture body in the adjusted position.

### BRIEF DESCRIPTION OF THE DRAWINGS

The above and other objects, advantages, and novel features of the present invention will become apparent from the following detailed description of the invention illustrated in the accompanying drawings, wherein:

FIG. 1 is an assembly drawing of the current invention.

FIG. 2 is a top view of the stem assembly and fixture body with the lighting element holders removed.

FIG. 3 is a bottom view of the fixture body, retaining washer, and retaining connector

FIG. 4 is a top view the keyed retaining washer of an alternative embodiment.

### DETAILED DESCRIPTION OF THE INVENTION

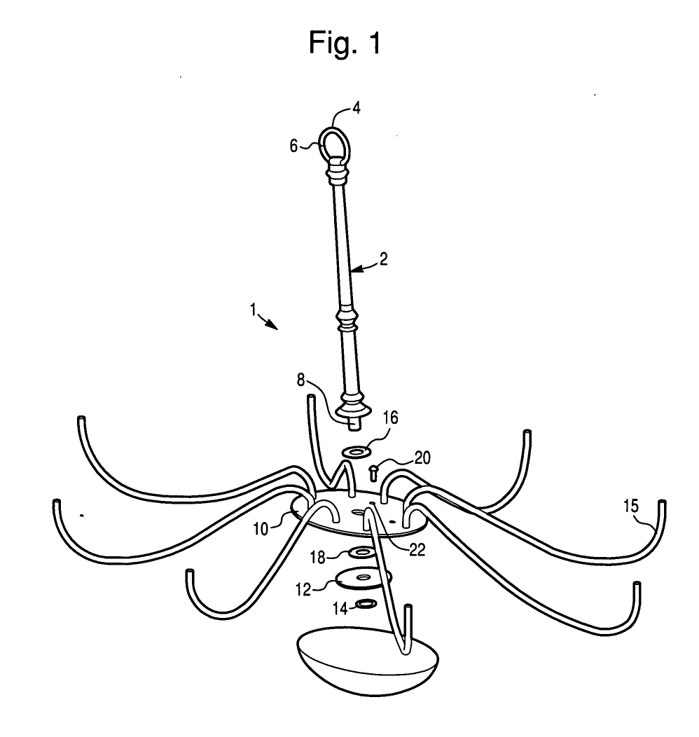

As best shown in FIG. 1, the present invention comprises a chandelier or hanging light fixture 1. The hanging light fixture 1 is comprised of a stem assembly 2 with an upper end 4 attached to a ceiling or a similar horizontal supporting member. The upper end 4 of the stem assembly 2 may include at least one link of a chain 6 or a similar connecting mechanism or assembly. The lower end 8 of the stem assembly 2 extends through the body 10 of the hanging light fixture 1 to engage a retaining washer 12 and a retaining connector 14. In the preferred embodiment, lighting element holders 15 extend from the body 10 of the light fixture 1.

As best shown in FIG. 1, an upper bearing 16 is positioned above the fixture body 10 and a lower bearing 18 is positioned below the fixture body 10 so that the fixture body 10 rotates on the bearings 16, 18. In the preferred embodiment, the upper bearing 16 directly abuts the upper portion of the fixture body 10 and the lower bearing 18 directly abuts the lower portion of the fixture body and the retaining washer 12.

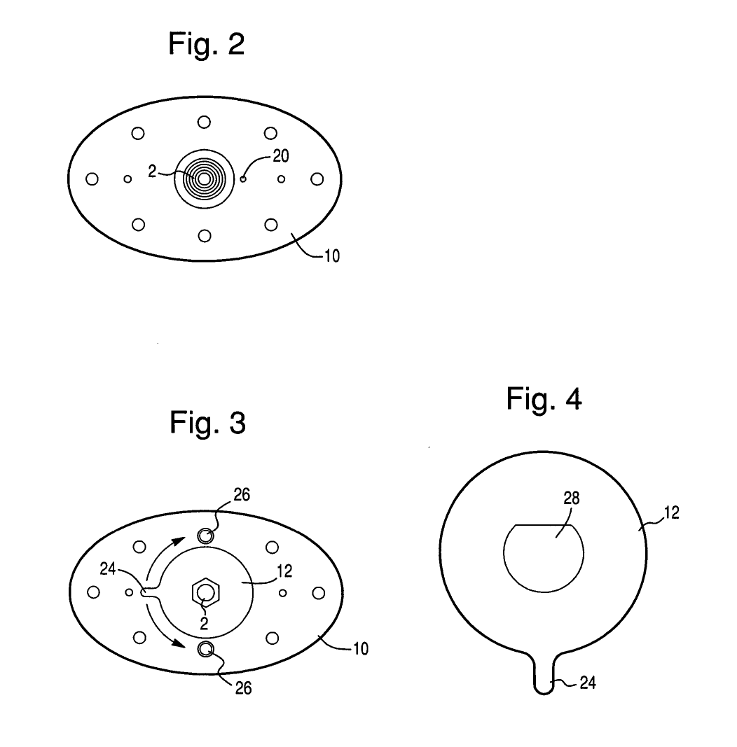

As best shown in FIGS. 1 and 2, the position of the body 10 of the fixture 1 can be locked in a specified position relative to the stem assembly 2 by the application of a fastening system, preferably a set screw 20. The set screw 20 extends through an aperture 22 in the fixture body 10 and frictionally engages the retaining washer 12. The retaining washer 12 is firmly fixed in position relative to the stem assembly 2. When the set screw is disengaged from the retaining washer 12, the fixture body 10 can freely rotate on the bearings 16, 18, relative to the stem assembly 2. Once the fixture body 10 has been re-positioned as desired, the set screw is re-tightened and the fixture body is locked in the new position. Although the preferred embodiment comprises a set screw 20 and retaining washer 12 mechanism, any fastening system effectively locking the fixture body 10 with the stem assembly 2 is within the scope of the invention.

As best shown in FIG. 3, the rotation of the fixture body 10 may be limited by contact between a retaining washer projection 24 and at least one barrier 26 extending from the bottom of the fixture body 10. In the preferred embodiment, two barriers 26 extend from the bottom of the fixture body 10 to limit rotation of the body 10 to 180° relative to the retaining washer 12 and stem assembly 2, as illustrated in FIG. 3. The barriers 26 may be comprised of connectors, excess weld material, or other components associated with connecting the lighting element holders 15 to the body 10 of the light fixture 1. The barriers may also be comprised of any other material or component consistent with the function of the barriers.

In the preferred embodiment, the retaining washer 12 is fixedly locked and attached to the distal end of the stem assembly 2 by welding the washer 12 to the stem assembly 2. The retaining connector 14 is also welded to the stem assembly 2. In an alternate embodiment, the retaining washer 12 has a keyed (eccentric) inner bore 28 that corresponds to the shape of the distal end of the stem assembly 2 so that the retaining washer 12 cannot rotate on the stem assembly 2, as best shown in FIG. 4. In another alternate embodiment, the retaining washer 12 is part of a threaded assembly that is tightened so that the retaining washer 12 does not rotate relative to the stem assembly. Additional embodiments whereby the rotation of the retaining washer 12 is fixedly locked to the stem assembly 2 should be considered within the scope of the invention.

In operation, the hanging light fixture 1 is installed in the same manner as a conventional chandelier or other hanging light fixture. When adjustment or maintenance is required, the set screw 20 (best shown in FIGS. 1 and 2) is loosened, thereby releasing the body 10 of the light fixture 1. The light fixture body 10 is then rotated on low friction bearings 16, 18 as required for maintenance, or to achieve a desired visual effect. When the adjustment or maintenance task is complete, the set screw 20 is re-tightened so that the set screw 20 re-engages the retaining washer 12 and maintains the body 10 of the fixture 1 in the desired position.

For the foregoing reasons it is clear that the current invention provides a hanging light fixture 1 that includes a simple and efficient means of controlling the position of the body 10 of the light fixture 1 without re-adjusting the entire fixture. For simplicity of illustration, the current invention has been described in the context or a relatively simple hanging light fixture. However, large, complex and elaborate lighting fixtures may incorporate the adjustment features of the current invention. In fact, the larger the size of the light fixture, the greater the time and labor savings that can be realized from the current invention. The relatively simple hanging light fixture disclosed herein is not intended to limit the scope of the invention. Additionally, the shape and configuration of the stem assembly, retaining washer, and the body of the fixture may include multiple additional decorative variations not shown in the drawings.

The invention, as described, may be applied in various applications and modified in multiple ways. Such variations are not to be regarded as a departure from the spirit of the invention, and all such modifications as would be obvious to one skilled in the art are intended to be included within the scope of the following claims. Although the materials of construction are not described, they may include a variety of compositions consistent with the function of the invention.

1. A light fixture comprising:
a stem assembly having a first end and a second end,
a fixture body having a connecting aperture adapted so that said stem assembly first end extends through said connecting aperture,
a washer having an inner bore positioned to engage said stem assembly first end,
a fastening system associated with said washer and said fixture body,
wherein said stem assembly first end extends through said fixture body connecting aperture and fixedly engages said washer, said washer being locked with said stem assembly, said fastening system engages said washer so that said fixture body is locked with said stem assembly and said washer.

2. The light fixture of claim 1 wherein said fixture body is unlocked from said stem assembly and said washer when said fastening system is disengaged with said washer, said fixture body being free to move relative to said stem assembly when said fastening system is disengaged.

3. The light fixture of claim 1 wherein said stem assembly second end is adapted to be connected to a horizontal supporting surface.

4. The light fixture of claim 1 wherein said stem assembly first end is adapted to receive keyed hardware, said washer having a keyed inner bore so that when said keyed washer engages said stem assembly said keyed washer is locked with said stem assembly.

5. The light fixture of claim 1 wherein said fastening system is comprised of a set screw extending through a threaded aperture in said fixture body to engage said washer.

6. The light fixture of claim 1 wherein said washer is welded to said stem assembly so that said washer is locked with said stem assembly.

7. The light fixture of claim 2 further comprising:
at least one barrier extending from said fixture body,
a projection extending from said washer,
wherein said projection engages said barrier thereby preventing said fixture body from rotating more than 360 degrees.

8. The light fixture of claim 2 further comprising:
at least two barriers extending from said fixture body,
a projection extending from said washer,
wherein said projection engages one of said barriers thereby preventing said fixture body from rotating more than 180 degrees.

9. The light fixture of claim 8 wherein said barriers are comprised of one of material or hardware associated with connecting lighting element holders to said fixture body.

10. The light fixture of claim 1 further comprising bearings.

11. The light fixture of claim 10 wherein said bearings are positioned one of above or below said fixture body.

12. The light fixture of claim 10 wherein said bearings are positioned above and below said fixture body.

13. The light fixture of claim 1 further comprising:
upper bearings abutting a first side of said fixture body, and
lower bearings abutting a second side of said fixture body, said lower bearings also abutting a first side of said washer to ensure easy rotation of said fixture body.

14. The light fixture of claim 1 wherein a retaining connector abuts a second side of said washer.

15. The light fixture of claim 1 wherein said stem assembly second end further comprises at least one chain link.

16. The light fixture of claim 1 wherein said stem assembly is tubular.

17. The light fixture of claim 1 wherein said light fixture body is asymmetrical.

18. The light fixture of claim 1 wherein said light fixture is a chandelier.

19. A hanging light fixture comprising:
a stem assembly having a first end and a second end, said stem assembly first end being adapted to be connected to a horizontal support surface,
a fixture body having a connecting aperture adapted so that said stem assembly second end extends through said connecting aperture,
a washer being welded to said stem assembly second end,
a set screw corresponding to a threaded aperture in said fixture body,
wherein said stem assembly second end extends through said fixture body connecting aperture and is welded to said washer so that said washer is locked to said stem assembly, said set screw extends through said threaded aperture to frictionally engage said washer so that said fixture body is locked with said stem assembly and said washer.

20. A chandelier comprising:
a stem assembly having a first end and a second end, said stem assembly first end being adapted to be connected to a ceiling,
a fixture body having a connecting aperture adapted so that said stem assembly second end extends through said connecting aperture, said fixture body having a first side and a second side,
an upper bearing abutting said first side of said fixture body,
a washer being welded to said stem assembly second end, said washer having a first side and a second side,
a lower bearing abutting said second side of said fixture body and said first side of said washer,
a set screw corresponding to a threaded aperture in said fixture body,
wherein said stem assembly second end extends through said fixture body connecting aperture and engages said washer so that rotation of said washer is locked to rotation of said stem assembly, said set screw extends through said threaded aperture to frictionally engage said washer so that rotation of said fixture body is locked with rotation of said stem assembly and said washer,
wherein said chandelier further comprises at least two barriers extending from said fixture body second side, and a projection extending from said washer so that said projection engages one of said barrier thereby preventing said fixture body from rotating more than 180 degrees when said set screw is not frictionally engaged with said washer.
